(19) United States
(12) Patent Application Publication
(10) Pub. No.: US 2005/0147862 A1
(43) Pub. Date: Jul. 7, 2005

(54) Fuel cell system and method for operating same

(76) Inventors: Andreas Knoop, Esslingen (DE); Volker Peinecke, Esslingen (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/494,984

(22) PCT Filed: Nov. 8, 2002
(86) PCT No.: PCT/EP02/12519

(30) Foreign Application Priority Data
Nov. 9, 2001 (DE) 101 55 217.3

(51) Int. Cl. H01M 8/04

(52) U.S. Cl. 429/34; 429/17

(57) ABSTRACT

A fuel cell system has recycle lines for recycling exhaust from the cathode and exhaust from the anode, with a recirculation device in each of the recycle lines. The recirculation devices are operated by a drive, such as a drive motor, with the drive and the two recirculation devices arranged on a common shaft.

### BACKGROUND OF THE INVENTION

1. Field of the Invention

The invention concerns a fuel cell system and a method for operating the same.

2. Description of the Related Art

Fuel cell systems typically contain fuel cell stacks that comprise a number of individual cells. The individual fuel cells and the stacks are usually supplied with reactant streams in parallel, with a hydrogen-containing fuel stream being supplied to the anode, and an oxidant stream, such as air or oxygen, being supplied to the cathode. Ideally, the reactants are essentially uniformly fed to all the individual cells, with even flow distribution. German Patent Application No. DE 199 29 472 A1 describes a fuel cell system of this type, for example.

However, achieving uniform distribution of reactants through a multitude of feed channels that are in close proximity to each other can be difficult, and can be dependent on the pressures and load ranges of the system. Accordingly, there remains a need for a fuel cell system, and a method for operating such a system, with a more reliably uniform distribution of reactant streams over a range of operating conditions.

### BRIEF SUMMARY OF THE INVENTION

The present fuel cell system comprises a fuel cell stack, comprising at least one fuel cell, each fuel cell comprising an anode and a cathode, a fuel feed line for supplying a hydrogen-containing fuel stream to the anode, an anode exhaust line to receive anode exhaust from the anode, an oxidant feed line for supplying an oxidant stream to the cathode, a cathode exhaust line to receive cathode exhaust from the cathode. An anode recycle line is provided for redirecting at least part of the anode exhaust from the anode exhaust line to the fuel feed line, a cathode recycle line is provided for redirecting at least part of the cathode exhaust from the cathode exhaust line to the oxidant feed line. A recirculation device, such as a fan or pump, is disposed in each of the anode recycle line and the cathode recycle line, and a drive for operating both of the recirculation devices is provided. The recirculation devices and the drive are arranged on a common shaft.

A method of operating the present fuel cell system comprises supplying the anode with a fuel stream at a fuel stream flow rate and a fuel stoichiometry and the cathode with an oxidant stream at an oxidant stream flow rate and an oxidant stoichiometry, wherein the fuel stoichiometry and the oxidant stoichiometry are greater than one. During periods when the output power demanded from the fuel cell stack is less than that available during “full-load” operation of the fuel cell stack (e.g. the normal maximum desirable power output which the stack is designed to provide), at least part of the cathode exhaust is recirculated at a first recirculation ratio, and at least part of the anode exhaust is recirculated at a second recirculation ratio.

This recirculation of depleted reactant streams maintains or increases the total flow rate through the anode chamber and the cathode chamber for a given reactant stoichiometry. This results in a higher pressure drop across the fuel cell stack, which in turn improves the uniformity of distribution of reactants in the fuel cell stack and improves water management, when the stack is operated at less than full power. By increasing the reactant stream flow rate through the cells under these conditions, the operation of the full cell stack become more stable and the distribution of individual cell voltages within the fuel cell stack becomes more even, as does the distribution of current density within and among the individual cells. This makes it possible to enhance the overall power output of the fuel cell stack.

In addition, by recirculating wet exhaust it becomes possible to adjust the humidity of the incoming reactant stream on the anode side and/or the cathode side, and the fuel cell system can be improved.

Further, including a water separator in the system allows an improved discharge of water from the system.

These and other aspects will be evident upon reference to the attached Figures and following detailed description.

### BRIEF DESCRIPTION OF THE DRAWINGS

FIG. 1 is a schematic illustration of one embodiment of the present fuel cell system and method.

FIG. 2 is a graph showing a typical variation of current versus voltage for a fuel cell.

### DETAILED DESCRIPTION OF THE INVENTION

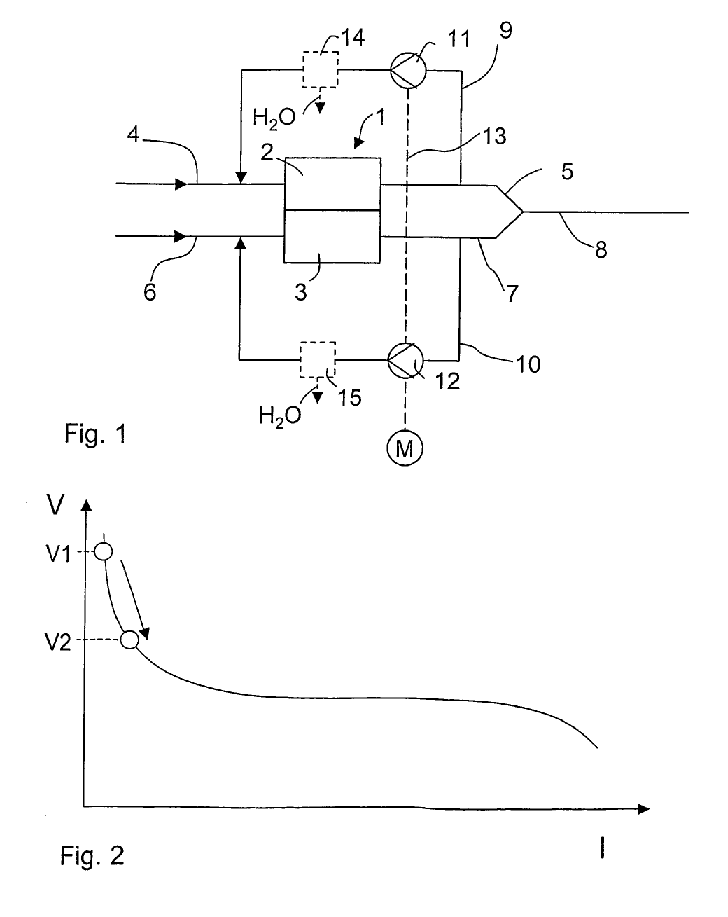

FIG. 1 shows part of one embodiment of the present fuel cell system. Fuel cell stack 1 comprises several single cells, which are arranged in a stack, whereby the individual reactant chambers are supplied with reactant streams in parallel. Accordingly, fuel cell stack 1 possesses multiple anodes, which collectively are referred to as anode 2, and multiple cathodes, which collectively are referred to as cathode 3.

A hydrogen-containing fuel stream is supplied to anode 2. The fuel stream may be, for example, pure hydrogen or a hydrogen-rich reformate stream. The fuel stream reaches anode 2 through a fuel feed line 4 connected to the anode 2. Anode exhaust is discharged from anode 2 through anode exhaust line 5. Cathode 3 is supplied with an oxidant stream, such as, for example, air or oxygen, through an oxidant feed line 6 connected to the cathode 3. Cathode exhaust is discharged from cathode 3 through cathode exhaust line 7. Anode exhaust line 5 and cathode exhaust line 7 may be joined further downstream to form a single exhaust line 8 as shown in FIG. 1, or may be kept separate.

At least part of the anode exhaust is recirculated from anode exhaust line 5 to fuel feed line 4 through a fuel recycle line 9. Similarly, at least part of the cathode exhaust is recirculated from cathode exhaust line 7 to oxidant feed line 6 through an oxidant recycle line 10. Recirculation devices, for recirculating at least part of each of the anode and cathode exhaust, are provided in the form of an anode fan 11 in anode recycle line 9 and a cathode fan 12 in cathode recycle line 10, respectively. Fans 11, 12 are equipped with a drive M, which in the illustrated embodiment is a common drive motor for both fans 11, 12.

Fans 11, 12 are arranged on a common shaft 13 with drive M. In one embodiment, drive M, cathode fan 12, and anode fan 11 are arranged in that sequence on common shaft 13. In such a configuration, where cathode fan 12 separates drive M and anode fan 11, hydrogen is prevented from reaching sensitive components of drive M. Thus, cathode fan 12 acts as a type of seal and at the same time protects the sensitive magnetic materials of the drive motor against embrittlement of the material, which could result from exposure to hydrogen. Magnetic materials, such as those used in electrical machines, are vulnerable to embrittlement as a result of hydrogen corrosion, which is one reason why anode exhaust recirculation can be problematic. In another embodiment, the oxidant stream pressure on the cathode side is kept higher than the fuel stream pressure on the anode side of fuel cell stack 1.

The proportion of the exhaust that is recirculated, i.e. the recirculation ratio, can be selected and adjusted so that the reactant stream flow rate and pressure drop across fuel cell stack 1, or across anode 2 and cathode 3, is essentially independent of the load that is demanded by the users of the fuel cell system (i.e. the output power demand). This recirculation of fuel and oxidant exhaust improves the uniformity of distribution of reactants within in fuel cell stack 1, particularly under no-load and partial-load conditions (e.g. idling). During no-load and partial-load operation, non-uniform reactant stream flow distribution can lead to the obstruction of the narrow reactant channels of the fuel cell stack by water droplets. Fuel cell exhaust recirculation can also make it possible to reduce the effect of local temperature differences, and to relax stringent manufacturing tolerances for the dimensions of the reactant stream flow channels which are typically required to ensure even flow distribution.

Furthermore, the fuel cell exhaust streams are generally at high humidity when they exit fuel cell stack 1. The exhaust stream is generally at saturation temperature. Thus, by employing fuel cell exhaust recirculation, humidified exhaust streams are returned to the fuel cell stack 1, which improves the water balance of the system, and can reduce the need for humidification of the reactant supply streams.

In another embodiment of the present system and method, where the drive is drive motor, the speed of the drive motor (and thereby the recirculation ratio) can be varied in dependence on the humidity of the supplied oxidant stream and/or the supplied fuel stream.

In still another embodiment of the present system and method, a water separator 14, 15 may be arranged in one or both of recycle lines 9, 10 on the cathode side and/or the anode side, as indicated by the dashed symbols in the figures. It is also possible to operate fans 11, 12 as water separators, such as centrifugal separators.

In one embodiment of the present method for operating a fuel cell system, during no-load operation or when not much power is required from fuel cell stack 1, the fuel stoichiometry and the oxidant stoichiometry are greater than necessary to produce the required power. Fuel stoichiometry and oxidant stoichiometry refer to the ratio between the quantity of actual reactant (fuel or oxidant) that is supplied to stack 1, and the quantity of reactant that is at that instant required for the reaction on the anode side and the cathode side of the fuel cell to satisfy the instantaneous power demand. The required mass flow of reactants during no-load and partial-load operation is comparably low. Thus, fans 11, 12 can recirculate a large amount of reactant-depleted anode and cathode exhaust and return it to anode 2 or cathode 3 of fuel cell stack 1, respectively, at the same time recirculating water. In some cases, this may eliminate the need for additional humidification of the “fresh” reactant streams supplied to fuel cell stack 1.

During full-load operation, the proportion of anode exhaust and/or cathode exhaust recirculated (i.e. the fuel and/or oxidant recirculation ratio) is less than during no-load or partial-load operation of the system. Even for an identical electrical output and identical speed of the drive motor during full-load operation, the delivery (recirculation) capacity is smaller than during partial-load operation due to the higher pressure and the higher pressure drop in the system at full load. The speed of the drive motor may be varied in dependence on the load on fuel cell stack 1.

In one embodiment, the amount of exhaust that is recirculated on the cathode side and the anode side, respectively, may be varied so that some flow of oxidant and fuel streams through fans 11, 12 is maintained even under full-load conditions, eliminating the possibility of the fresh reactant supply streams bypassing of fuel cell stack 1 through recycle lines 9, 10. Alternatively, in another embodiment, a check valve(s) that prevents the fuel and/or the oxidant supply streams from bypassing fuel cell stack 1 through recycle lines 9, 10 may be employed.

As shown in FIG. 2, for very small currents, i.e. under partial-load or no-load conditions, the characteristic current-voltage curve shows a very high voltage. As the current increases, the voltage initially drops rapidly and subsequently only changes by a small amount over a large range of increasing current. The slope of the voltage drop increases again at very high currents.

A very high voltage peak V1 will occur in a fuel cell stack 1 during no-load operation with a current near 0 A. If—during the start-up of the system or during no-load operation—drive M for fans 11, 12 is engaged first, then this comparably small electrical load will result in a voltage drop from V1 to V2. When further electrical loads or electrical components of the fuel cell system are subsequently connected, they are then protected against this initial voltage peak.

Accordingly, in one embodiment of the present system, when operation of the fuel cell system is commenced, fuel cell stack 1 is started by being supplied with fuel and oxidant. This gives rise to the (high) open-circuit voltage in accordance with FIG. 2. Subsequently, fuel cell stack 1 supplies power to fans 11, 12 as the first electrical loads supplied with power from the stack, whereupon fuel cell stack 1 is connected to supply power to other fuel cell system components and to additional electrical loads. Thus, the other electrical components of the fuel cell system, and the loads, do not have to be protected against the high initial overvoltage and consequently can be less expensive.

In one embodiment of the present system and method, a DC motor, such as a simple fixed-speed DC motor, may be employed as drive M for fans 11, 12. In another embodiment, a variable-speed electric motor may be employed as drive M for fans 11, 12, in which case the speed of the motor can be used to adjust the volumetric flow rate of the recirculated fuel and oxidant exhaust streams, and thereby the humidity of the reactant streams being supplied to fuel cell stack 1. An operating curve based on the appropriate operating characteristics of fuel cell stack 1 can be initially generated in dependence on the load, so that during operation the stored operating data may be used and the recirculation ratios can be adjusted to a desirable value accordingly.

In still another embodiment, open-loop or closed-loop speed control may be used to obtain desirable operation. For example, this can be used to set specific saturation temperatures of the supplied reactant streams or specific pressure drops across fuel cell stack 1, whereby the reactant stream flow rates and the power demand of the electric motor may be variable.

As the output power of the fuel cell stack increases, the fuel cell voltage drops. At the same time, the throughput of fans 11, 12 and the recirculation ratios are reduced. This a higher fuel cell power output results in a significantly lower recirculation rate of the fuel cell exhaust streams, since the voltage of the fuel cell is lower and the pressure drop of both reactant streams across the fuel cell is higher.

One embodiment of the present system and method employs a high recirculation ratio under partial-load and no-load conditions. In addition, some degree of recirculation may be maintained during full-load operation to prevent the already-mentioned bypassing of the fuel cell stack by fresh reactant streams. This can also prevent overheating of fans 11, 12. Thus, under partial-load conditions a large amount of cathode exhaust and anode exhaust is recirculated, while a small amount is recirculated during full-load operation.

For example, if during full-load operation 300 kg/h of air with an oxidant stoichiometry of approximately 1.5, a pressure of approximately 2.8 bar, and a relative humidity of approximately 39%, is supplied to the cathode, then fan 12 on the cathode side may additionally deliver approximately 10 kg/h of saturated cathode exhaust to cathode 3 at a pressure of approximately 2.5 bar. This results in a recirculation ratio of 10/300=0.03. The relative humidity of the oxidant stream that is supplied to cathode 3 increases to about 44%. Even higher saturation temperatures and relative humidity values can be achieved if cathode 3 of fuel cell stack 1 is supplied by a compressor and supply system that also humidifies the air.

During partial-load operation, fan 12 delivers more cathode exhaust (recirculated air), e.g. 80 kg/h, while only a small amount of fresh oxidant stream (air) is supplied. In this case, the recirculation ratio is between approximately 4 and 5—much higher than during full-load operation. During no-load operation and partial-load operation, the recirculation ratio may be higher by a factor of at least 10, and in one embodiment, is higher by a factor of at least 100, than during full-load operation, whereby the fan power demand during full-load operation is only approximately 1% of the electrical power output of the fuel cell system at full load. During no-load or partial-load operation, ⅓ of the fan power input at full load is sufficient to drive the fan or fans 11, 12. For example, for a fuel cell system with an electrical output of approximately 70 kW, such as a fuel cell system suitable for vehicle drives, a fan input power of less than 700 W would be sufficient under full-load conditions and less than approximately 200 W would be sufficient under partial-load conditions.

Furthermore, the present system and method make it possible to lower the fuel stoichiometry and/or the oxidant stoichiometry throughout a wide load range and consequently enables reduced reactant consumption during fuel cell operation. This strongly increases the system efficiency during partial-load operation. During start-up or shutdown of the system it is possible to discharge water from the fuel cell stack without a wasting fuel or oxidant. This is especially advantageous during conditioning of fuel cell stack 1.

By means of the present system and method, the constituents of the fuel stream, such as hydrogen, water, CO₂, etc., will be distributed more reliably uniformly in the cells. This results in a lower maximum chemical/thermal load on fuel cell stack 1. The maximum loads on the fuel cell stack due to electrical current density and waste heat flux are also lower.

A higher water input may be possible on the air side if the oxidant stream that is being supplied is also humidified. This can reduce drying-out in the cathode inlet area of fuel cell stack 1.

It is also possible to lower the air stoichiometry on the cathode side of fuel cell stack 1 during partial-load operation.

If the fuel cell system is shut down while it is delivering power, the recirculation can, at least initially, provide humidification.

Stresses on electrical system components that may arise when fuel cell stack 1 is connected to the system are reduced, since the high no-load voltage of fuel cell stack 1 is cropped or reduced. Further, cell conditioning with respect to the humidity during start-up or shutdown of the system is simplified.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A fuel cell system comprising:
a fuel cell stack, comprising at least one fuel cell, each fuel cell comprising an anode and a cathode,
a fuel feed line for supplying a fuel stream to the anode,
an anode exhaust line to receive anode exhaust from the anode,
an oxidant feed line for supplying an oxidant stream to the cathode,
a cathode exhaust line to receive cathode exhaust from the cathode,
an anode recycle line, to recirculate at least part of the anode exhaust from the anode exhaust line to the fuel feed line,
a cathode recycle line, to recirculate at least part of the cathode exhaust from the cathode exhaust line to the oxidant feed line,
a recirculation device disposed in each of the anode recycle line and the cathode recycle line, and
a drive for operating the recirculation devices, wherein the recirculation devices and the drive are arranged on a common shaft.

2. The fuel cell system of claim 1, wherein the drive is a drive motor.

3. The fuel cell system of claim 2, wherein the drive motor is a DC motor.

4. The fuel cell system of claim 3, wherein the drive motor is a fixed-speed DC motor.

5. The fuel cell system of claim 2, wherein the drive motor is a variable-speed electric motor.

6. The fuel cell system of claim 2, wherein the following elements are arranged on the common shaft in the following sequence: the drive motor, the recirculation device disposed in the cathode recycle line, and the recirculation device disposed in the anode recycle line.

7. The fuel cell system of claim 1, further comprising a water separator disposed in at least one of the anode recycle line and the cathode recycle line.

8. The fuel cell system of claim 1, wherein at least one of the recirculation devices is configured to function as a water separator.

9. The fuel cell system of claim 1, further comprising a check valve in each of the anode recycle line and the cathode recycle line.

10. A method of operating the fuel cell system of claim 1, the method comprising:
supplying the anode with the fuel stream at a fuel stream flow rate and a fuel stoichiometry and the cathode with the oxidant stream at an oxidant stream flow rate and an oxidant stoichiometry, wherein the fuel stoichiometry and the Qxidant stoichiometry are greater than one, and
during periods when an output power demand on the fuel cell stack is less than that available during full-load operation of the fuel cell stack, recirculating at least part of the cathode exhaust at a first recirculation ratio and at least part of the anode exhaust at a second recirculation ratio.

11. The method of claim 10, further comprising electrically connecting the drive as the first electrical load to the fuel cell stack during start-up of the fuel cell system.

12. The method of claim 10, further comprising supplying the oxidant stream at a higher pressure than the fuel stream.

13. The method of claim 10, wherein when the output power demand is less than that available during full-load operation of the fuel cell stack, and at least one of the first re-circulation ratio and the second recirculation ratio is greater than during full-load operation of the fuel cell stack.

14. The method of claim 10, further comprising adjusting the first recirculation ratio and the second recirculation ratio such that the pressure drop across the fuel cell stack is essentially independent of the output power demand.

15. The method of claim 10, wherein during full-load operation the first recirculation ratio and the second recirculation ratio are greater than zero.

16. The method of claim 10, further comprising varying at least one of the first recirculation ratio and the second recirculation ratio depending on the humidity of at least one of the oxidant stream and the fuel stream being supplied to the fuel cell stack.

17. The method of claim 10, wherein the drive is a variable-speed electric motor, and the method further comprises varying the speed of the electric motor depending on at least one of the output power demand, the fuel stream flow rate, the oxidant stream flow rate, the humidity of the oxidant stream being supplied, and the humidity of the fuel stream being supplied.

18. The method of claim 10, further comprising the step of operating at least one of the recirculation devices as a water separator.
